(19) United States
(12) Patent Application Publication
(10) Pub. No.: US 2010/0086848 A1
(43) Pub. Date: Apr. 8, 2010

(54) NONAQUEOUS ELECTROLYTE SECONDARY BATTERY AND ACTIVE MATERIAL FOR NONAQUEOUS ELECTROLYTE SECONDARY BATTERY

(75) Inventors: Masanobu Takeuchi, Kobe-city (JP); Atsushi Ogata, Kobe-city (JP); Hiroyuki Fujimoto, Kobe-city (JP); Osamu Shindo, Osaka (JP); Hideaki Shimizu, Osaka (JP); Susumu Morita, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Moriguchi-city (JP); JAPAN NEW METALS CO., LTD., Toyonaka-city (JP)

(21) Appl. No.: 12/571,761

(22) Filed: Oct. 1, 2009

(30) Foreign Application Priority Data
Oct. 2, 2008 (JP) 2008-257266

(51) Int. Cl. H01M 6/04

(52) U.S. Cl. 429/188

(57) ABSTRACT

In a nonaqueous electrolyte secondary battery and an active material for a nonaqueous electrolyte secondary battery, the nonaqueous electrolyte secondary battery includes: a positive electrode containing a positive-electrode active material; a negative electrode containing a negative-electrode active material; and a nonaqueous electrolyte, wherein molybdenum dioxide whose particles have an average aspect ratio of two or less is used as the positive-electrode active material or the negative-electrode active material where the aspect ratio is the ratio between the major axis length and the minor axis length of a particle-equivalent ellipse equivalent to the cross-sectional area or the two-dimensional projection image of each of the observed particles (major axis length/minor axis length), the particle-equivalent ellipse being an ellipse having the same area and the same first and second moments as the observed particle.

### BACKGROUND OF THE INVENTION

1. Field of the Invention

This invention relates to nonaqueous electrolyte secondary batteries, and particularly relates to nonaqueous electrolyte secondary batteries usable as memory backup power sources for portable devices and the like, and to active materials for the nonaqueous electrolyte secondary batteries.

2. Description of Related Art

High electromotive force nonaqueous electrolyte secondary batteries using a nonaqueous electrolytic solution have recently been widely used as high output, high energy density secondary batteries. Such nonaqueous electrolyte secondary batteries are used not only as main power sources for portable devices but also as memory backup power sources for portable devices. In recent years, there has been a demand for increase in the energy density of main power sources for portable devices, and also a growing demand for increase in the energy density of memory backup power sources.

An example of such a secondary battery for memory backup having been practically used is a battery in which lithium cobaltate (LiCoO₂) is used as a positive-electrode active material and lithium titanate (Li₄Ti₅O₁₂) having a spinel structure is used as a negative-electrode active material. Another example is a battery structure in which lithium titanate is used for a positive electrode and carbon containing lithium is used for a negative electrode. However, the density and gravimetric capacity of lithium titanate used as a negative-electrode active material or a positive-electrode active material are 3.47 g/ml and 175 mAh/g, respectively. Therefore, lithium titanate has a problem in that the energy density per volume is low. Molybdenum dioxide reversibly reacts with lithium in a potential range similar to that of lithium titanate, and its density and gravimetric capacity are 6.44 g/ml and 210 mAh/g, respectively. Thus, molybdenum dioxide has a high energy density per volume as compared with lithium titanate. Therefore, by using molybdenum dioxide in place of lithium titanate, the energy density per volume of the battery can be increased.

For example, Published Japanese Patent Application Nos. 2000-243454, 2006-269152 and 2007-227358 propose batteries in which a lithium-containing cobalt oxide or a lithium-containing nickel oxide is used as a positive-electrode active material and molybdenum dioxide is used for a negative electrode.

Published Japanese Patent Application No. S63-30321 discloses molybdenum dioxide obtained by reducing molybdenum trioxide or ammonium molybdate and having an excellent flowability, and a method for producing the same.

### SUMMARY OF THE INVENTION

Secondary batteries for memory backup are incorporated as built-in batteries in devices, and used without any protection circuit in view of their mounting area and cost. The secondary batteries for memory backup are normally used in a fully charged state by power supply from their main power sources. However, it is expected that if no power continues to be supplied from the main power sources to the batteries for a long time, the batteries will enter an over-discharged state. Therefore, secondary batteries for memory backup are required to have excellent over-discharge cycle characteristic.

In the production of molybdenum dioxide, a technique of obtaining molybdenum dioxide by reducing molybdenum trioxide in a flow of hydrogen gas is commonly used such as because of ease of production of fine molybdenum dioxide. In this case, because molybdenum trioxide has a layered structure, it generally has a plate-like particle form and, therefore, molybdenum dioxide particles finally obtained are likely to also have a form derived from the source material. Accordingly, most of commonly available molybdenum dioxide products have thin plate-like particle form. If molybdenum dioxide having such a particle form is used as an active material for a battery, crystals are easily oriented in the same direction in producing an electrode. It has been found that, for this reason, a problem arises in that strains of the electrode due to expansion and contraction upon lithium storage and release of molybdenum dioxide are concentrated in a single direction of the electrode and, therefore, the conductive path in the electrode is broken, whereby the battery cannot ensure a sufficient over-discharge cycle characteristic.

An object of the present invention is to provide a nonaqueous electrolyte secondary battery usable as a memory backup power source and having a large battery capacity and an excellent over-discharge cycle characteristic, and provide an active material for the nonaqueous electrolyte secondary battery.

The present invention provides a nonaqueous electrolyte secondary battery including: a positive electrode containing a positive-electrode active material; a negative electrode containing a negative-electrode active material; and a nonaqueous electrolyte, wherein molybdenum dioxide whose particles have an average aspect ratio of two or less is used as the positive-electrode active material or the negative-electrode active material where the aspect ratio is the ratio between the major axis length and the minor axis length of a particle-equivalent ellipse equivalent to the cross-sectional area or the two-dimensional projection image of each of the observed particles (major axis length/minor axis length), the particle-equivalent ellipse being an ellipse having the same area and the same first and second moments as the observed particle.

In the present invention, molybdenum dioxide whose particles have an average aspect ratio of two or less is used as the positive-electrode active material or the negative-electrode active material where the aspect ratio is the ratio between the major axis length and the minor axis length of a particle-equivalent ellipse equivalent to the cross-sectional area or the two-dimensional projection image of each of the observed particles (major axis length/minor axis length), the particle-equivalent ellipse being an ellipse having the same area and the same first and second moments as the observed particle. If, as described previously, molybdenum dioxide particles having a thin plate-like form are used as an active material for a battery, crystals are easily oriented in the same direction in producing an electrode. For this reason, strains of the electrode due to expansion and contraction upon lithium storage and release of molybdenum dioxide are concentrated in a single direction of the electrode and, therefore, the conductive path in the electrode is broken, whereby the battery cannot obtain a sufficient over-discharge cycle characteristic. In contrast, since in the present invention molybdenum dioxide whose particles have an average aspect ratio of two or less is used, the electrode exhibits no anisotropy in the lithium insertion and elimination reactions, the electrode reaction proceeds smoothly, and side reactions during each over-discharge cycle are less likely to occur. Therefore, capacity degradation during each over-discharge cycle can be reduced.

The aspect ratio of molybdenum dioxide particles is preferably small, but its minimum value is one by definition. If the variance of the aspect ratios of the particles is large, the particles include a large number of plate-like particles. Therefore, the variance is preferably 1.5 or less.

The average of ratios of maximum to minimum Feret diameters for the particles is preferably two or less where the Feret diameter is the distance between two parallel lines sandwiching an image of each particle, and the variance thereof is preferably 1.5 or less for the same reason as the variance of the aspect ratios.

Furthermore, particles representing 80% of the areas of the cross-sectional images or two-dimensional projection images of all the particles, excluding coarse particles representing the largest 10% of the image areas and small particles representing the smallest 10% of the image areas, preferably have an average aspect ratio or average maximum to minimum Feret diameter ratio of two or less, and preferably have an aspect ratio variance or maximum to minimum Feret diameter ratio variance of one or less.

In order to inhibit expansion and contraction of the electrode upon lithium storage and release of molybdenum dioxide, it is effective to use, as the active material, molybdenum dioxide containing nitrogen within the range of 0.01% to 0.20% by weight. Since nitrogen is contained in the crystal structure of molybdenum dioxide, crystal defects occur, which inhibits changes in the crystal structure upon lithium storage and release. If the nitrogen content is smaller than 0.01% by weight, there may be cases where the number of defects in the crystal structure is small and, therefore, the above effect cannot sufficiently be expected. On the other hand, if the nitrogen content is larger than 0.2% by weight, there may be cases where the valence of Mo cannot be maintained at four, a MoO₂ single phase is less likely to be obtained and, therefore, the specific capacity is reduced.

The valence of Mo in molybdenum dioxide is preferably four. If molybdenum oxide having a different valence, such as MoO_{2.75}, is mixed into the molybdenum dioxide, the initial efficiency and the cycle characteristic may be degraded.

In preparing molybdenum dioxide according to the present invention, a method of obtaining molybdenum dioxide by reducing ammonium molybdate is preferably used, and highly preferably, a method of reducing and calcining ammonium paramolybdate (3(NH₄)₂O.7MoO₃.4H₂O) in a flow of hydrogen gas is used. The temperature of reduction and calcination is preferably within the range of 500 to 600° C.

If a method of reducing and calcining molybdenum trioxide in a flow of hydrogen gas is used as the method of preparing molybdenum dioxide, particles of an obtained crystal structure are likely to have a thin plate-like form as described above.

Another method of preparing molybdenum dioxide is a method of oxidizing molybdenum metal. However, if this method is used, it is difficult to provide a MoO₂ single-phase state. Specifically, other phases, such as MoO_{2.75}, are likely to be mixed into MoO₂ owing to the progress of oxidation, or molybdenum metal is likely to be mixed into MoO2 owing to the lack of oxidation.

In order to obtain an excellent over-discharge cycle characteristic, it is effective to use a mixture of the above-stated molybdenum dioxide and lithium titanate (Li₄Ti₅O₁₂). Because lithium titanate slightly changes its volume with storage and release of lithium, the over-discharge cycle characteristic is improved by mixing lithium titanate with molybdenum dioxide. However, this effect varies significantly depending upon the particle form of the molybdenum dioxide. If lithium titanate is mixed with molybdenum dioxide whose particles have an aspect ratio larger than two, the unidirectional orientation of molybdenum dioxide in the electrode cannot be eliminated, and strains of the electrode due to expansion and contraction upon lithium storage and release of molybdenum dioxide are concentrated in a single direction of the electrode. Therefore, the conductive path in the electrode is broken, whereby the effect due to mixture of lithium titanate cannot sufficiently be obtained. By mixing molybdenum dioxide whose particles have an aspect ratio not larger than two and lithium titanate, the over-discharge cycle characteristic is further improved. Furthermore, the molybdenum dioxide and lithium titanate are preferably used by mixing them in a weight ratio ranging from 75:25 to 25:75. If the lithium titanate content is not larger than 25% by weight, the effect cannot sufficiently be obtained. If the lithium titanate content is not smaller than 75% by weight, a sufficient charge/discharge capacity cannot be obtained.

When the molybdenum dioxide in the present invention is used as a negative-electrode active material, lithium-containing transition metal composite oxides commonly used as a positive-electrode active material for a nonaqueous electrolyte secondary battery, such as lithium cobaltate, lithium nickelate, spinel lithium manganate or lithium-containing cobalt-nickel-manganese composite oxides, may be used as a positive-electrode active material.

When the molybdenum dioxide in the present invention is used as a positive-electrode active material, for example, carbon materials such as graphite, metals alloyed with lithium, such as aluminium or silicon, or the like may be used as a negative-electrode active material. By using these materials as a negative-electrode active material, there can be provided a nonaqueous electrolyte secondary battery exhibiting an operating voltage of about 2.0 to 1.0 V.

Solvents which may be used for a nonaqueous electrolyte in the present invention include cyclic carbonate solvents, such as ethylene carbonate, propylene carbonate and butylene carbonate, and chain carbonate solvents, such as diethyl carbonate, ethyl methyl carbonate and dimethyl carbonate. Preferably, it is desirable to use a mixture of a cyclic carbonate solvent and a chain carbonate solvent. More preferably, the solvent contains 5 to 30% by volume of ethylene carbonate. If the ethylene carbonate content is less than 5% by volume, a sufficient lithium ion conductivity may not be obtained in the nonaqueous electrolyte. On the other hand, if the ethylene carbonate content is more than 30% by volume, a coating of decomposition products of ethylene carbonate may be excessively formed on the negative-electrode active material to degrade the cycle characteristic.

Solutes which may be used for a nonaqueous electrolyte in the present invention include lithium hexafluorophosphate (LiPF₆), lithium tetrafluoroborate (LiBF₄), LiTFSI (LiN(CF₃SO₂)₂), LiBETI (LiN(C₂F₅SO₂)₂).

Since the nonaqueous electrolyte secondary battery according to the present invention is excellent in over-discharge cycle characteristic as described above, it can be suitably used as a secondary battery for memory backup.

The present invention also provides an active material for a nonaqueous electrolyte secondary battery, the active material being molybdenum dioxide whose particles have an average aspect ratio of two or less where the aspect ratio is the ratio between the major axis length and the minor axis length of a particle-equivalent ellipse equivalent to the cross-sectional area or the two-dimensional projection image of each of the observed particles (major axis length/minor axis length), the particle-equivalent ellipse being an ellipse having the same area and the same first and second moments as the observed particle.

By using the active material for a nonaqueous electrolyte secondary battery according to the present invention as a positive-electrode active material or a negative-electrode active material, there can be provided a nonaqueous electrolyte secondary battery excellent in over-discharge cycle characteristic.

The active material for a nonaqueous electrolyte secondary battery according to the present invention may be obtained by hydrogen reducing ammonium paramolybdate as described above.

The active material for a nonaqueous electrolyte secondary battery according to the present invention can be used as a positive-electrode active material or a negative-electrode active material for a nonaqueous electrolyte secondary battery to provide a nonaqueous electrolyte secondary battery excellent in over-discharge cycle characteristic. Therefore, the active material can be suitably used as an active material for a secondary battery for memory backup.

The nonaqueous electrolyte secondary battery according to the present invention has a large battery capacity, and exhibits an excellent over-discharge cycle characteristic.

By using the active material for a nonaqueous electrolyte secondary battery according to the present invention as a positive-electrode active material or a negative-electrode active material for a nonaqueous electrolyte secondary battery, there can be provided a nonaqueous electrolyte secondary battery having a large battery capacity and an excellent over-discharge cycle characteristic.

### BRIEF DESCRIPTION OF THE DRAWINGS

FIG. 1 is a scanning electron micrograph showing molybdenum dioxide particles prepared in an example according to the present invention.

FIG. 2 is a cross-sectional observation view for observing the shapes of molybdenum dioxide particles prepared in the example according to the present invention.

FIG. 3 is a cross-sectional view showing a nonaqueous electrolyte secondary battery produced in the example according to the present invention.

FIG. 4 is a scanning electron micrograph showing molybdenum dioxide particles in a comparative example.

FIG. 5 is a cross-sectional observation view for observing the shapes of molybdenum dioxide particles in the comparative example.

FIG. 6 is a graph showing the over-discharge cycle characteristic of the nonaqueous electrolyte secondary battery in the example according to the present invention.

FIG. 7 is a graph showing the charge-discharge cycle characteristic of the nonaqueous electrolyte secondary battery in the example according to the present invention when measured under conditions where the battery does not enter an over-discharged state.

### DETAILED DESCRIPTION OF THE PREFERRED EXAMPLES

Hereinafter, the present invention will be described in more detail with reference to the following Examples. However, the present invention is not at all limited by the following Examples, and can be embodied in various other forms appropriately modified without changing the spirit of the invention.

### Example 1

### Synthesis of Molybdenum Dioxide and Measurement of Particle Form Thereof

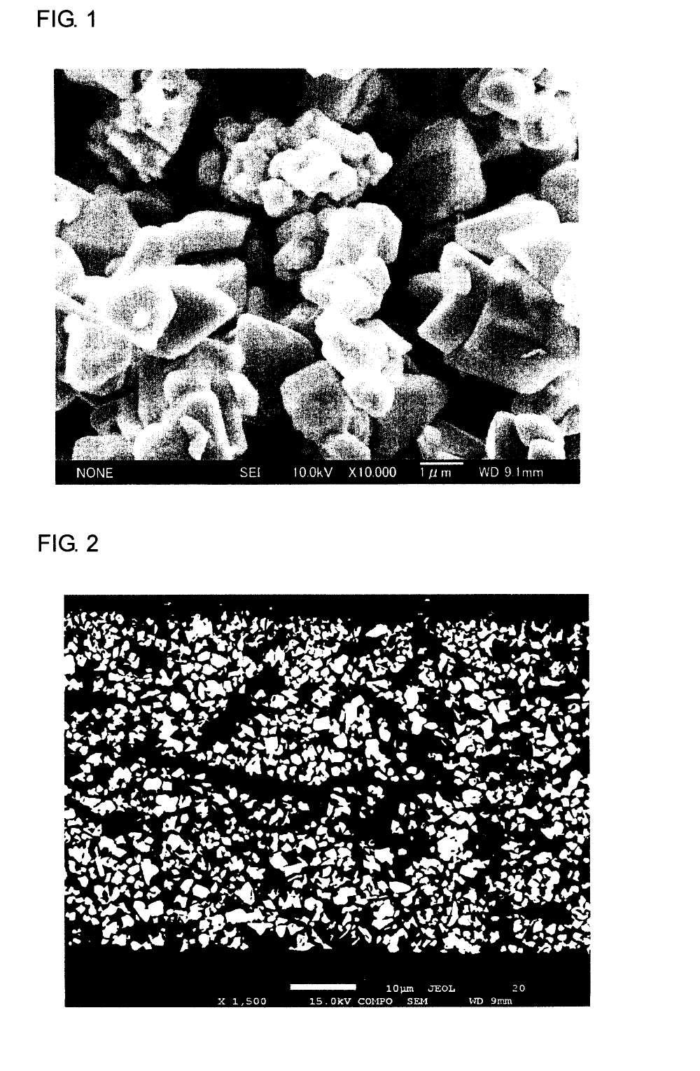

Ammonium paramolybdate (3(NH₄)₂O.7MoO₃.4H₂O) was reduced and calcined in a flow of hydrogen gas at 570° C. for two hours, thereby obtaining molybdenum dioxide. The proportion by weight of nitrogen in molybdenum dioxide thus obtained was measured by thermal conductimetry. The proportion of nitrogen was 0.09% by weight. The mean particle size of molybdenum dioxide particles measured by an air-permeability method (Fisher Sub-Sieve Sizer), the specific surface area thereof measured by the BET method, the bulk density thereof measured using a hopper, and the tapped density thereof measured by a constant volume method were 2.28 μm, 0.79 m²/g, 1.22 g/cm³ and 1.59 g/cm³, respectively. FIG. 1 shows an image of molybdenum dioxide thus obtained, as observed by a scanning electron microscope (SEM). The figure shows that molybdenum dioxide of this example was constituted by aggregated particles having a small aspect ratio, whereas molybdenum dioxide of Comparative Example as will be described hereinafter was constituted by plate-like particles (see FIG. 4).

The obtained molybdenum dioxide and poly(vinylidene fluoride) (PVdF) were mixed in a solvent of N-methylpyrrolidinone (NMP), and applied onto an aluminium foil. The mixture on the foil was cut and polished with an argon ion beam, followed by observation of the cross-sectional shapes of molybdenum dioxide particles with an SEM. FIG. 2 shows the cross-sectional images of the particles observed. In FIG. 2, the highlights correspond to molybdenum dioxide particles.

The observed cross-sectional images were analyzed using Image-Pro Plus manufactured by Media Cybernetics, Inc. The average of aspect ratios obtained from cross-sectional images of 455 molybdenum dioxide particles was 1.86, and the variance thereof was 0.97. The average of maximum Feret diameter to minimum Feret diameter ratios of the particles was 1.83, and the variance thereof was 0.79.

Particles representing 80% of the areas of the observed cross-sectional images, excluding coarse particles representing the largest 10% of the image areas and small particles representing the smallest 10% of the image areas, have an average aspect ratio of 1.79 and an aspect ratio variance of 0.57.

The average of maximum Feret diameter to minimum Feret diameter ratios of the main particles representing 80% of the image areas was 1.71, and the variance thereof was 0.44.

[Production of Positive Electrode]

LiCoO₂, acetylene black, artificial graphite and poly(vinylidene fluoride) (PVdF) were mixed in a weight ratio of 94:2.5:2.5:1 in a solvent of NMP, dried, and then milled, thereby obtaining a positive-electrode mixture. The mixture was put into a molding tool of 4.16 mm diameter, and molded under a pressure of 800 kgf, thereby producing a disc-shaped positive electrode.

[Production of Negative Electrode]

After mixing MoO₂ and Li₄Ti₅O₁₂ as an active material in a weight ratio of 75:25, the active material, artificial graphite and PVdF were mixed in a weight ratio of 91.5:7.5:1 in a solvent of NMP, dried, and then milled, thereby obtaining a negative-electrode mixture. The mixture was put into a molding tool of 4.16 mm diameter, and molded under a pressure of 800 kgf, thereby producing a disc-shaped negative electrode.

[Preparation of Electrolytic Solution]

Lithium hexafluorophosphate (LiPF₆) was dissolved as a solute in a solvent of mixture of ethylene carbonate and diethyl carbonate in a volume ratio of 3:7 so that its concentration was 1 mole per liter of the solvent, thereby preparing a nonaqueous electrolytic solution.

[Assembly of Battery]

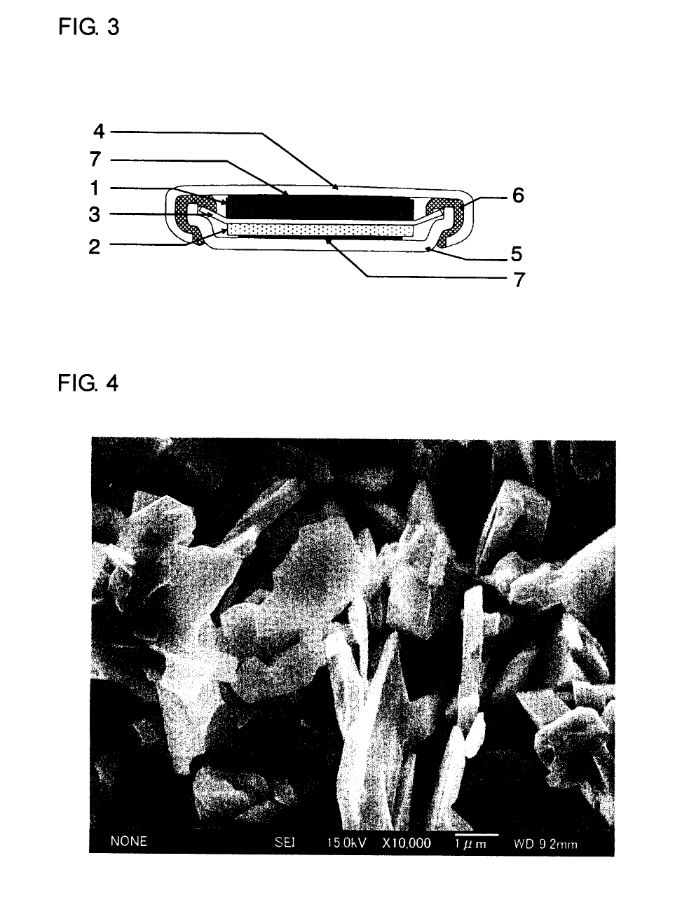

Using the above positive electrode, negative electrode and nonaqueous electrolytic solution, a flat battery A1 according to the example of the present invention as shown in FIG. 3 (a nonaqueous electrolyte secondary battery having a battery size of 6 mm diameter and 1.4 mm thickness) was produced. The positive electrode 1 and the negative electrode 2 are arranged to oppose each other with a separator 3 therebetween, and housed in a battery case formed of a positive electrode can 4 and a negative electrode can 5. The positive electrode 1 and the negative electrode 2 are connected to the positive electrode can 4 and the negative electrode can 5, respectively, each through a conductive paste 7 made of carbon. The peripheral portion of the negative electrode can 5 is fitted inside the positive electrode can 4 through a gasket 6 made of polypropylene. Nonwoven fabric made of polyphenylene sulfide is used as the separator 3. The positive electrode 1, the negative electrode 2 and the separator 3 are impregnated with the above nonaqueous electrolytic solution.

### Comparative Example 1

### Synthesis of Molybdenum Dioxide and Measurement of Particle Form Thereof

Molybdenum trioxide was reduced and calcined in a flow of hydrogen gas at 540° C. for four hours, thereby obtaining molybdenum dioxide. The proportion by weight of nitrogen in molybdenum dioxide thus obtained was measured by thermal conductimetry. No nitrogen was detected. Note that the detection limit is 10 ppm (0.001%). The mean particle size of molybdenum dioxide particles measured by an air-permeability method (Fisher Sub-Sieve Sizer), the specific surface area thereof measured by the BET method, the bulk density thereof measured using a hopper, and the tapped density thereof measured by a constant volume method were 1.48 μm, 0.95 m²/g, 0.44 g/cm³ and 1.14 g/cm³, respectively. FIG. 4 shows an image of molybdenum dioxide thus obtained, as observed by an SEM.

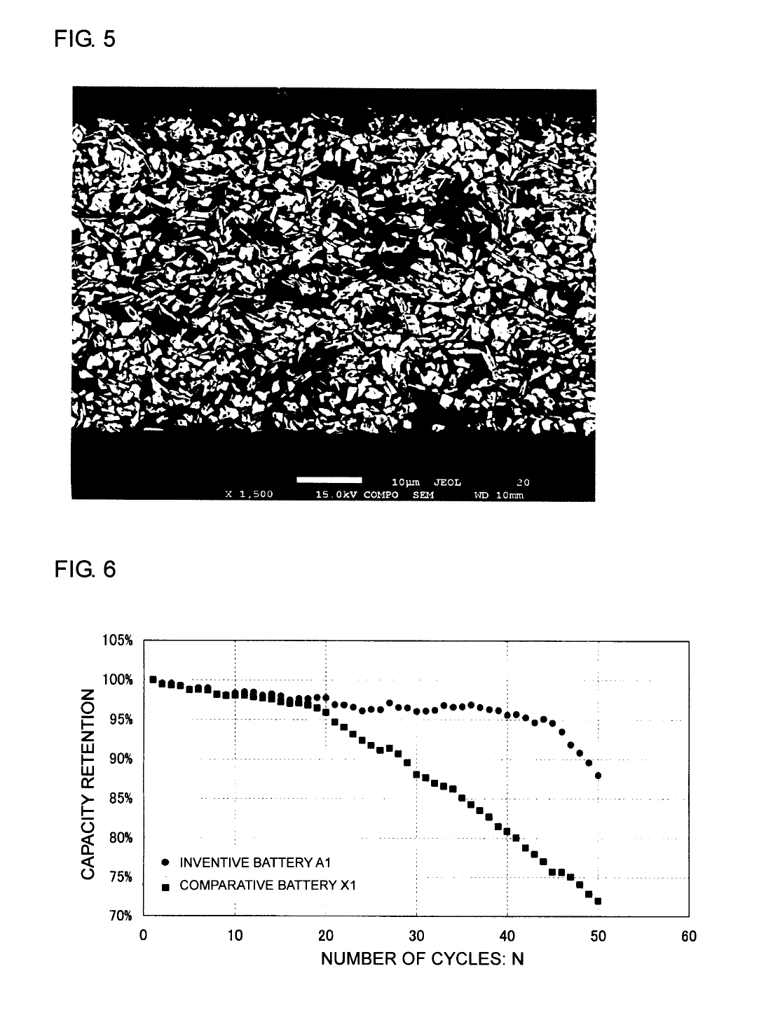

The obtained molybdenum dioxide and PVdF were mixed in a solvent of NMP, and applied onto an aluminium foil. The mixture on the foil was cut and polished with an argon ion beam, followed by observation of the cross-sectional shapes of molybdenum dioxide particles with an SEM. FIG. 5 shows the cross-sectional images of the particles observed. In FIG. 5, the highlights correspond to molybdenum dioxide particles.

The observed cross-sectional images were analyzed using Image-Pro Plus manufactured by Media Cybernetics, Inc. The average of aspect ratios obtained from cross-sectional images of 754 molybdenum dioxide particles was 2.73, and the variance thereof was 1.66. The average of maximum Feret diameter to minimum Feret diameter ratios of the particles was 2.62, and the variance thereof was 1.50.

Particles representing 80% of the areas of the observed cross-sectional images, excluding coarse particles representing the largest 10% of the image areas and small particles representing the smallest 10% of the image areas, have an average aspect ratio of 2.52 and an aspect ratio variance of 1.59.

The average of maximum Feret diameter to minimum Feret diameter ratios of the main particles representing 80% of the image areas was 2.32, and the variance thereof was 1.25.

[Production of Battery]

Using molybdenum dioxide prepared in the above manner, a battery X1 according to the comparative example was produced in the same manner as in the inventive example except for production of the negative electrode.

[Evaluation of Over-Discharge Cycle Characteristic]

The above inventive battery A1 according to Example 1 and the comparative battery X1 according to Comparative Example 1 were evaluated for over-discharge cycle characteristic in the following manner.

Over-Discharge Cycle Characteristic Measurement Conditions
Charging: charging at a constant current of 100 μA to a cut-off voltage of 3.2 V
Discharging: discharging at a constant current of 100 μA to a cut-off voltage of 0.01 V
Pause: 10 seconds

Capacity retentions after the first to fiftieth cycles were calculated using the following equation based on results of measurement according to the above cycle characteristic measurement conditions.

Capacity retention (%)={(discharge capacity after each cycle)/(discharge capacity after the first cycle)}100

FIG. 6 shows capacity retentions at each cycle.

As is obvious from FIG. 6, the inventive battery A1 using as an active material molybdenum dioxide having an average particle aspect ratio of two or less retained 88% of the initial discharge capacity after the 50th cycle. On the other hand, the capacity retention of the comparative battery X1 after the 50th cycle was 72%. This shows that when a battery uses as an active material molybdenum dioxide having an average particle aspect ratio of two or less according to the present invention, the battery obtains an excellent over-discharge cycle characteristic.

Reasons why a battery obtains an excellent over-discharge cycle characteristic by using as an active material molybdenum dioxide having an average particle aspect ratio of two or less according to the present invention can be seen as follows. Specifically, molybdenum dioxide used for the comparative battery X1 is constituted by thin plate-like particles, and its crystals are likely to be oriented in the same direction in producing an electrode. For this reason, it can be seen that strains of the electrode due to expansion and contraction upon lithium storage and release of molybdenum dioxide are concentrated in a single direction of the electrode and, therefore, the conductive path in the electrode is broken, whereby the battery cannot obtain a sufficient over-discharge cycle characteristic. In contrast, it can be seen that since molybdenum dioxide used for the inventive battery A1 has a particle aspect ratio of two or less, strains in the electrode are relieved and the conductive pass is inhibited from being broken, whereby the battery obtains an excellent over-discharge cycle characteristic. Furthermore, since particles of molybdenum dioxide used for the inventive battery A1 grow isotropically and, therefore, the electrode exhibits no anisotropy in the lithium insertion and elimination reactions, the electrode reaction proceeds smoothly, and side reactions during each over-discharge cycle are less likely to occur. Also from this, it can be seen that capacity degradation during each over-discharge cycle can be reduced.

(Reference Experiment)

The inventive battery A1 and the comparative battery X1 were evaluated for charge-discharge cycle characteristic under the following conditions.

Cycle Characteristic Measurement Conditions
Charging: charging at a constant current of 100 μA to a cut-off voltage of 3.2 V
Discharging: discharging at a constant current of 100 μA to a cut-off voltage of 2.0 V
Pause: 10 seconds

Although in the measurement conditions for the over-discharge cycle characteristic the discharge cut-off voltage is 0.01 V, the measurement conditions in the reference experiment is different from the former in that the discharge cut-off voltage is 2.0 V.

Capacity retentions after the first to fiftieth cycles were calculated in the same manner as above based on results of measurement according to the above cycle characteristic measurement conditions.

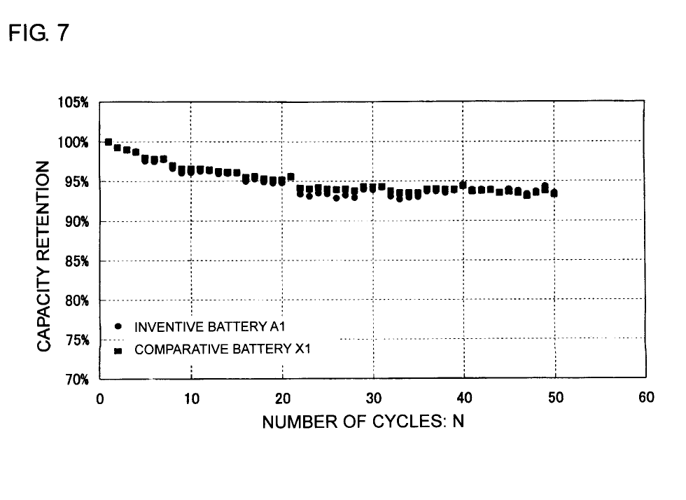

FIG. 7 shows capacity retentions at each cycle.

As is obvious from FIG. 7, under the conditions where the discharge cut-off voltage was 2.0 V so as not to put the batteries into an over-discharged state, the inventive battery A1 and the comparative battery X1 had substantially equal cycle characteristics. This result shows that the nonaqueous electrolyte secondary battery according to the present invention is very useful as a backup secondary battery that is used without any protection circuit and can be expected to enter an over-discharged state as a result of long-term continuation of a situation in which no power is supplied from the main power source.

What is claimed is:

1. A nonaqueous electrolyte secondary battery comprising:
a positive electrode containing a positive-electrode active material;
a negative electrode containing a negative-electrode active material; and
a nonaqueous electrolyte,
wherein molybdenum dioxide whose particles have an average aspect ratio of two or less is used as the positive-electrode active material or the negative-electrode active material where the aspect ratio is the ratio between the major axis length and the minor axis length of a particle-equivalent ellipse equivalent to the cross-sectional area or the two-dimensional projection image of each of the observed particles (major axis length/minor axis length), the particle-equivalent ellipse being an ellipse having the same area and the same first and second moments as the observed particle.

2. The nonaqueous electrolyte secondary battery of claim 1, wherein the molybdenum dioxide contains nitrogen within the range of 0.01% to 0.20% by weight.

3. The nonaqueous electrolyte secondary battery of claim 1, wherein a mixture of the molybdenum dioxide and lithium titanate in a weight ratio (molybdenum dioxide:lithium titanate) ranging from 75:25 to 25:75 is used as the active material.

4. The nonaqueous electrolyte secondary battery of claim 2, wherein a mixture of the molybdenum dioxide and lithium titanate in a weight ratio (molybdenum dioxide:lithium titanate) ranging from 75:25 to 25:75 is used as the active material.

5. The nonaqueous electrolyte secondary battery of claim 1, wherein the molybdenum dioxide is used as the negative-electrode active material, and a lithium-transition metal composite oxide is used as the positive-electrode active material.

6. The nonaqueous electrolyte secondary battery of claim 2, wherein the molybdenum dioxide is used as the negative-electrode active material, and a lithium-transition metal composite oxide is used as the positive-electrode active material.

7. The nonaqueous electrolyte secondary battery of claim 3, wherein the molybdenum dioxide is used as the negative-electrode active material, and a lithium-transition metal composite oxide is used as the positive-electrode active material.

8. The nonaqueous electrolyte secondary battery of claim 4, wherein the molybdenum dioxide is used as the negative-electrode active material, and a lithium-transition metal composite oxide is used as the positive-electrode active material.

9. The nonaqueous electrolyte secondary battery of claim 1, wherein the molybdenum dioxide is a substance obtained by reducing ammonium molybdate.

10. The nonaqueous electrolyte secondary battery of claim 2, wherein the molybdenum dioxide is a substance obtained by reducing ammonium molybdate.

11. The nonaqueous electrolyte secondary battery of claim 9, wherein the ammonium molybdate is ammonium paramolybdate.

12. The nonaqueous electrolyte secondary battery of claim 10, wherein the ammonium molybdate is ammonium paramolybdate.

13. The nonaqueous electrolyte secondary battery of claim 1, wherein the molybdenum dioxide is a substance obtained by hydrogen reducing ammonium paramolybdate.

14. The nonaqueous electrolyte secondary battery of claim 2, wherein the molybdenum dioxide is a substance obtained by hydrogen reducing ammonium paramolybdate.

15. An active material for a nonaqueous electrolyte secondary battery, the active material being molybdenum dioxide whose particles have an average aspect ratio of two or less where the aspect ratio is the ratio between the major axis length and the minor axis length of a particle-equivalent ellipse equivalent to the cross-sectional area or the two-dimensional projection image of each of the observed particles (major axis length/minor axis length), the particle-equivalent ellipse being an ellipse having the same area and the same first and second moments as the observed particle.

16. The active material for a nonaqueous electrolyte secondary battery of claim 15, the active material being molybdenum dioxide obtained by reducing ammonium molybdate.

17. The active material for a nonaqueous electrolyte secondary battery of claim 16, wherein the ammonium molybdate is ammonium paramolybdate.

18. The active material for a nonaqueous electrolyte secondary battery of claim 15, wherein the molybdenum dioxide is a substance obtained by hydrogen reducing ammonium paramolybdate.

19. The active material for a nonaqueous electrolyte secondary battery of claim 16, wherein the molybdenum dioxide is a substance obtained by hydrogen reducing ammonium paramolybdate.

20. The active material for a nonaqueous electrolyte secondary battery of claim 17, wherein the molybdenum dioxide is a substance obtained by hydrogen reducing ammonium paramolybdate.
